(19) United States
(12) Patent Application Publication
(10) Pub. No.: US 2026/0119556 A1
(43) Pub. Date: Apr. 30, 2026

(54) METHOD AND SYSTEM FOR RETRIEVING INFORMATION

(71) Applicant: SAMSUNG SDS CO., LTD., Seoul (KR)

(72) Inventors: Jae Sun SHIN, Seoul (KR); Dong Woo Kim, Seoul (KR); Hye Rim Hong, Seoul (KR); Joon Yi Kim, Seoul (KR); Min Young Lee, Seoul (KR)

(73) Assignee: SAMSUNG SDS CO., LTD., Seoul (KR)

(21) Appl. No.: 19/357,708

(22) Filed: Oct. 14, 2025

(30) Foreign Application Priority Data
Oct. 30, 2024 (KR) 10-2024-0151212

(51) Int. Cl. G06F 16/334

(52) U.S. Cl. CPC G06F 16/3347

(57) ABSTRACT

A method for retrieving information may include inputting a query to a pre-trained information retrieval model, and determining a plurality of pieces of retrieval target information corresponding to the query among a plurality of pieces of candidate information, based on an output from the information retrieval model, wherein the plurality of pieces of retrieval target information includes first retrieval target information and second retrieval target information, wherein the first retrieval target information is automatically determined from among the plurality of pieces of candidate information, based on a similarity of each of the plurality of pieces of candidate information to the query, wherein the second retrieval target information is automatically determined from among first remaining ones of the plurality of pieces of candidate information other than the first retrieval target information, based on a similarity of each of the first remaining ones to the first retrieval target information.

### CROSS-REFERENCE TO RELATED APPLICATION

This application claims priority from Korean Patent Application No. 10-2024-0151212 filed on Oct. 30, 2024, in the Korean Intellectual Property Office, and all the benefits accruing therefrom under 35 U.S.C. 119, the contents of which in its entirety are herein incorporated by reference.

### BACKGROUND

### Field

The present disclosure relates to a method and system for retrieving information. Specifically, the present disclosure relates to a method for retrieving information corresponding to a query from an information pool and a system for performing the method.

### Description of Related Art

In a method of retrieving information corresponding to a query, a plurality of pieces of information having a high similarity to the query may be extracted from an information pool.

In this regard, top-1 information having the highest similarity to the query among a plurality of pieces of information included in the information pool may be extracted, and the remaining information except for the top-1 information among the extracted plurality of pieces of information may be data having a high similarity to the top-1 information.

For example, when a query representing a request for sending a general mail to an executive and employee is input to a retrieval model, a ‘general mail sending API’ having the highest similarity to the query may be extracted from the information pool. As a ‘confidential mail sending API’ has a high similarity to the extracted ‘general mail sending API’, the ‘confidential mail sending API’ having a high probability of having a high similarity to the query may be extracted.

Accordingly, a retrieval priority of the ‘executive and employee retrieval API’ having a high similarity to the query but a low similarity to the extracted ‘general mail sending API’ may be lower than a retrieval priority of the ‘confidential mail sending API’. Thus, a problem in which the ‘executive and employee retrieval API’ actually required to process the query request is not extracted may occur.

Therefore, there is a need for a new information retrieval method for solving this problem.

### SUMMARY

A technical purpose to be achieved by embodiments of the present disclosure is to provide a method for determining retrieval target information corresponding to a query in consideration of a similarity of each of a plurality of pieces of candidate information with the query among the plurality of pieces of candidate information in performing multi-step retrieval and a computing system for performing the method.

Another technical purpose to be achieved by embodiments of the present disclosure is to provide a method for determining retrieval target information corresponding to a query in consideration of a similarity between a plurality of pieces of information, and a computing system for performing the method.

Still another technical purpose to be achieved by embodiments of the present disclosure is to provide a method for determining a weight of a similarity between a plurality of pieces of information serving as a criterion for determining retrieval target information corresponding to a query, and a computing system for performing the method.

The technical purposes to be achieved by the present disclosure are not limited to the technical purposes as mentioned above, and other technical purposes not mentioned may be clearly understood by those skilled in the art related to the present disclosure based on the following detailed descriptions.

According to an aspect of the present disclosure, there is provided a method for a method for retrieving information performed by a computing system. The method may include obtaining a query and inputting the query to a pre-trained information retrieval model, and determining a plurality of pieces of retrieval target information corresponding to the query among a plurality of pieces of candidate information, based on an output from the information retrieval model, wherein the plurality of pieces of retrieval target information may include first retrieval target information and second retrieval target information, wherein the first retrieval target information may be automatically determined using the output from the information retrieval model from among the plurality of pieces of candidate information, based on a similarity of each of the plurality of pieces of candidate information to the query, wherein the second retrieval target information may be automatically determined using the output from the information retrieval model from among first remaining ones of the plurality of pieces of candidate information other than the first retrieval target information, based on a similarity of each of the first remaining ones to the first retrieval target information.

In some embodiments, wherein the second retrieval target information may be determined from among the first remaining ones, based on a difference value between a similarity of each of the first remaining ones to the query and a value obtained by multiplying the similarity of each of the first remaining ones to the first retrieval target information a weight.

In some embodiments, the method may be further include determining the weight, wherein the determining of the weight may include obtaining a validation data set and inputting the validation data set to the information retrieval model, and determining the weight based on an output from the information retrieval model, wherein the weight may be obtained by optimizing a preset initial weight to maximize performance of the information retrieval model on the validation data set.

In some embodiments, wherein the plurality of pieces of retrieval target information further may include third retrieval target information, wherein the third retrieval target information may be automatically determined using the output from the information retrieval model from among second remaining ones of the plurality of pieces of candidate information other than the first retrieval target information and the second retrieval target information, based on a similarity of each of the second remaining ones to the query, a similarity of each of the second remaining ones to the first retrieval target information, and a similarity of each of the second remaining ones to the second retrieval target information.

According to another aspect of the present disclosure, there is provided a computer program stored in a computer-readable recording medium, wherein when the computer program is executed by a computing device, the computer program may cause the computing device to obtain a query and input the query to a pre-trained information retrieval model, and determine a plurality of pieces of retrieval target information corresponding to the query among a plurality of pieces of candidate information, based on an output from the information retrieval model, wherein the plurality of pieces of retrieval target information includes first retrieval target information and second retrieval target information, wherein the first retrieval target information may be automatically determined using the output from the information retrieval model from among the plurality of pieces of candidate information, based on a similarity of each of the plurality of pieces of candidate information to the query, wherein the second retrieval target information may be automatically determined using the output from the information retrieval model from among first remaining ones of the plurality of pieces of candidate information other than the first retrieval target information, based on a similarity of each of the first remaining ones to the first retrieval target information.

According to yet another aspect of the present disclosure, there is provided a system for retrieving information. The system comprises at least one processor and at least one memory storing therein instructions, wherein when the instructions are executed by the at least one processor, the instructions may cause the at least one processor to obtain a query and input the query to a pre-trained information retrieval model, and determine a plurality of pieces of retrieval target information corresponding to the query among a plurality of pieces of candidate information, based on an output from the information retrieval model, wherein the plurality of pieces of retrieval target information may include first retrieval target information and second retrieval target information, wherein the first retrieval target information may be automatically determined using the output from the information retrieval model from among the plurality of pieces of candidate information, based on a similarity of each of the plurality of pieces of candidate information to the query, wherein the second retrieval target information may be automatically determined using the output from the information retrieval model from among first remaining ones of the plurality of pieces of candidate information other than the first retrieval target information, based on a similarity of each of the first remaining ones to the first retrieval target information.

### BRIEF DESCRIPTION OF DRAWINGS

The above and other aspects and features of the present disclosure will become more apparent by describing in detail various embodiments thereof with reference to the attached drawings, in which:

FIG. 1 is a block diagram illustrating an example of a retrieval management system to which an information retrieval system according to an embodiment of the present disclosure may be applied;

FIG. 2 is a flowchart illustrating an information retrieval method according to an embodiment of the present disclosure;

FIG. 3 is a flowchart illustrating an example of all operations of an information retrieval system according to some embodiments of the present disclosure;

FIG. 4 is a flowchart illustrating a process of determining a weight of a similarity between retrieval target information and candidate information according to some embodiments of the present disclosure;

FIG. 5 is a flowchart illustrating an example of a process of optimizing a weight of a similarity between retrieval target information and candidate information according to some embodiments of the present disclosure; and

FIG. 6 is a block diagram illustrating an example of a computing device for performing some embodiments of the present disclosure.

### DETAILED DESCRIPTIONS

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

In addition, in describing the component of the present disclosure, terms, such as first, second, A, B, (a), (b), may be used. These terms are only for distinguishing the components from other components, and the nature or order of the components is not limited by the terms.

In the following embodiments, components described with reference to terms such as “part,” “unit,” “module,” “block,” or other similar terms used in the following descriptions and depicted as functional blocks in the accompanying drawings can be implemented as software, hardware, or a combination thereof. The software may include, for example, machine code, firmware, embedded code, and application software. Additionally, the hardware may include, for example, electrical circuits, electronic circuits, processors, computers, integrated circuits, integrated circuit cores, passive elements, or combinations thereof.

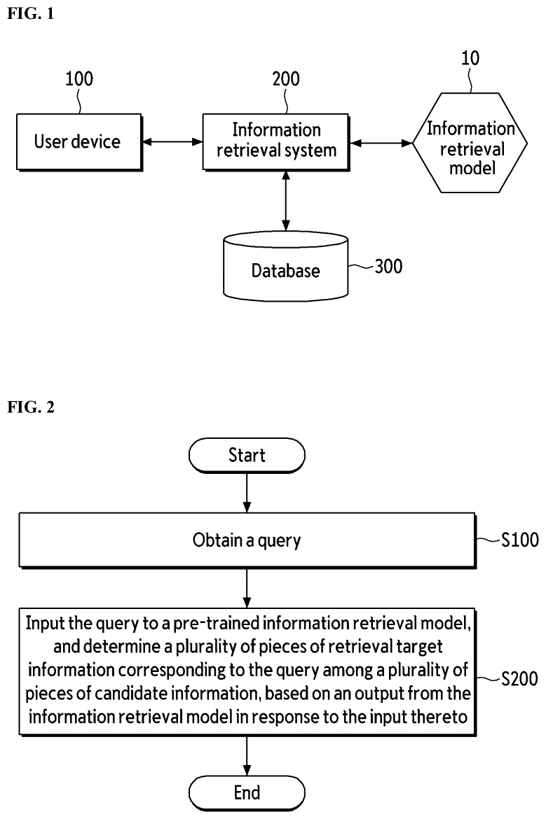

FIG. 1 is a block diagram illustrating an example of a retrieval management system to which an information retrieval system according to an embodiment of the present disclosure may be applied.

The retrieval management system of FIG. 1 may provide a framework for performing methods and/or operations according to some embodiments of the present disclosure. For example, the retrieval management system may retrieve retrieval target information corresponding to a query input from a user in an information pool including a plurality of pieces of information, and provide a framework for providing the retrieved retrieval target information to the user.

Referring to FIG. 1, the retrieval management system may include a user device 100, an information retrieval system 200, an information retrieval model 10, and/or database 300.

The user device 100 may include each of various devices used by the user to transmit and receive various data and/or information to and from another device via communicating therewith.

In the present disclosure, the user may refer to a person who inputs the query as an information retrieval target according to some embodiments of the present disclosure.

The user device 100 may include a smartphone, a tablet PC, a laptop, or the like, but is not limited thereto. For example, the user device 100 may include each of various computing devices including a wireless communication means and/or a computing means. The user device 100 may be referred to as a user terminal, a wireless device, a mobile terminal, a portable device, or the like.

The user device 100 may be used to use the information retrieval system 200 according to embodiments of the present disclosure. For example, the user device 100 may transmit a query representing a request input from the user to the information retrieval system 200. In another example, the user device 100 may display a user interface for an application in which a function of the information retrieval system 200 is implemented.

In the present disclosure, the query may mean a request input from a user as the information retrieval target, and the query may be referred to as a request, etc.

The information retrieval system 200 may perform multi-step retrieval by performing methods and/or operations according to some embodiments of the present disclosure using the information retrieval model 10 and/or the database 300.

In the present disclosure, the multi-step retrieval may mean determining a plurality of pieces of candidate information corresponding to a query among a plurality of pieces of candidate information as retrieval target information.

The information retrieval system 200 may obtain the query and determine retrieval target information corresponding to the query from among a plurality of pieces of candidate information using the information retrieval model 10. In addition, the information retrieval system 200 may transmit the retrieval target information corresponding to the query as determined according to some embodiments of the present disclosure to the user device 100.

The candidate information may mean information related to the query, and the candidate information may be formed in various forms. For example, the candidate information may be a passage, an application programming interface (API), or the like for processing a request/task related to the query.

The information retrieval system 200 may input the query to the information retrieval model 10 and determine one or more retrieval target information corresponding to the query among the plurality of pieces of candidate information based on an output from the information retrieval model 10.

The information retrieval model 10 may be a model pre-trained so as to calculate a similarity between the input query and the candidate information.

In this regard, each of the query and the candidate information may be data formed in a form of an embedding vector, and the information retrieval model 10 may be a model pre-trained so as to calculate a vector similarity between the embedding vector of the query and the embedding vector of the candidate information.

In addition, the information retrieval model 10 may be a model pre-trained to calculate a similarity between a plurality of pieces of information. For example, the information retrieval model 10 may calculate a similarity between the retrieval target information and the candidate information. In another example, the information retrieval model 10 may calculate a similarity between each of a plurality of pieces of retrieval target information and the candidate information.

In this regard, each of the retrieval target information and the candidate information may be data formed in the form of an embedding vector, and the information retrieval model 10 may be a model pre-trained to calculate a vector similarity between the embedding vector of the retrieval target information and the embedding vector of the candidate information.

In addition, the information retrieval model 10 may calculate the similarity between each of the plurality of pieces of candidate information and the input query and/or the similarity between the plurality of pieces of information (i.e., the similarity between the retrieval target information and the candidate information), and may output the calculated similarity and/or the candidate information corresponding to the calculated similarity.

The database 300 may refer to storage storing various types of information/data therein. For example, the database 300 may include information database (DB) including the plurality of pieces of candidate information, validation DB including a validation data set for validation of the information retrieval model 10, etc.

The database 300 may include one or more Artificial Intelligence (AI)-based models according to some embodiments of the present disclosure. For example, the database 300 may include a query embedding model pre-trained to generate an embedding vector of the query in a form of a natural language. In another example, the database 300 may include an information embedding model pre-trained to generate an embedding vector of information (e.g., candidate information) of each of various forms.

The information retrieval system 200 may perform a step/operation for obtaining the embedding vector of the query and/or the embedding vector of the candidate information according to some embodiments of the present disclosure using one or more models included in the database 300.

The information retrieval system 200 may be implemented on at least one computing device. For example, all functions of the information retrieval system 200 may be implemented on one computing device. In another example, some functions of the information retrieval system 200 may be implemented on a first computing device, and the remaining functions thereof may be implemented on a second computing device. Further, specific functions of the information retrieval system 200 may be implemented on one or more computing devices.

The components illustrated in FIG. 1 may communicate with each other over various types of wired/wireless networks. The device and/or system according to the present disclosure may be applicable to a Local Area Network (LAN), a Wide Area Network (WAN), a mobile radio communication network, a wireless broadband internet (Wibro), etc. However, the present disclosure is not limited thereto. The device and/or system according to the present disclosure may be applicable to any other communication system.

Hereinafter, embodiments in which a computing system performs information retrieval according to embodiments of the present disclosure will be described in detail with reference to FIGS. 2 to 5. For reference, FIGS. 2 to 5 illustrate steps/operations performed in the retrieval management system and/or the information retrieval system 200. Accordingly, in the following description, when a subject of a specific step/operation is omitted, it may be understood that the step/operation is performed in the retrieval management system 200 and/or the information retrieval system 200. Hereinafter, the present disclosure will be described with reference to FIG. 1 together with FIGS. 2 to 5.

In addition, it should be noted that the technical idea that may be understood from the embodiments described with reference to FIGS. 2 to 5 may be obviously applied to the computing system according to the embodiments described with reference to FIG. 1 unless otherwise specified.

FIG. 2 is a flowchart illustrating an information retrieval method according to an embodiment of the present disclosure.

Referring to FIG. 2, a query as an information retrieval target may be obtained in S100.

The query may be input to the pre-trained information retrieval model 10, and a plurality of pieces of retrieval target information corresponding to the query among the plurality of pieces of candidate information may be determined based on the output from the information retrieval model 10 in S200. In this regard, the query and/or the candidate information may be formed in the form of the embedding vector.

In S200, the retrieval target information included in the plurality of pieces of retrieval target information may be automatically determined from among the plurality of pieces of candidate information, based on the output from the information retrieval model 10 in response to the query.

As described with reference to FIG. 1, the information retrieval model 10 may be a model pre-trained so as to calculate a similarity between the query and the candidate information and/or a similarity between the plurality of pieces of candidate information.

According to some embodiments of the present disclosure, when the candidate information satisfies a predetermined criterion for determining the candidate information as the retrieval target information, the information retrieval model 10 may output the similarity calculated based on the candidate information and/or information on the candidate information (e.g., candidate information, a retrieval priority, a retrieval score, etc.).

In addition, in S200, a preset number of a plurality of pieces of retrieval target information may be determined from among the plurality of pieces of candidate information.

In S200, the retrieval target information may be automatically determined based on the similarity of each of the plurality of pieces of candidate information to the query from among the plurality of pieces of candidate information.

For example, in S200, the candidate information having the highest similarity to the query among the plurality of pieces of candidate information may be determined as the retrieval target information.

In S200, the retrieval target information may be automatically determined based on a similarity of each of the plurality of pieces of candidate information to another retrieval target information from among the plurality of pieces of candidate information.

For example, the plurality of pieces of retrieval target information determined in S200 may include first retrieval target information and second retrieval target information. The first retrieval target information may be determined from among a plurality of pieces of candidate information based on a similarity of each thereof with the query. The second retrieval target information may be determined from among the remaining ones of the plurality of pieces of candidate information other than the first retrieval target information, based on a similarity of each thereof with the first retrieval target information.

In S200, the retrieval target information determined based on the similarity thereof with another retrieval target information may be automatically determined in consideration of not only the similarity thereof with the query but also the similarity thereof with another retrieval target information.

For example, the plurality of pieces of retrieval target information determined in S200 may include first retrieval target information and second retrieval target information. The second retrieval target information may be determined from among the remaining ones of the plurality of pieces of candidate information other than the first retrieval target information, based on a difference value between the similarity of each thereof to the query and a value obtained by multiplying the similarity thereof to the first retrieval target information by a weight.

In this regard, the weight is a value assigned to the similarity between a plurality of pieces of information serving as a criterion for determining the retrieval target information corresponding to the query (e.g., the similarity between the first retrieval target information and candidate information different from the first retrieval target information). The weight may be set to an optimized value according to some embodiments of the present disclosure.

For example, in S200, the information retrieval model 10 which has received the query may determine the candidate information having the highest similarity to the query among the plurality of pieces of candidate information as the first retrieval target information, and may determine one candidate information from among the remaining ones of the plurality of pieces of candidate information except for the first retrieval target information as the second first retrieval target information, wherein a difference value between the similarity of the determined one candidate information to the query and a value obtained by multiplying the similarity thereof to the first retrieval target information by the weight may be the largest.

In another example, the plurality of pieces of retrieval target information determined in S200 may include the first retrieval target information, the second retrieval target information, and third retrieval target information. The third retrieval target information may be determined from among the remaining ones of the plurality of pieces of candidate information other than the first retrieval target information and the second retrieval target information, based on the similarity of each thereof to the query, the similarity of each thereof to the first retrieval target information, and the similarity of each thereof to the second retrieval target information.

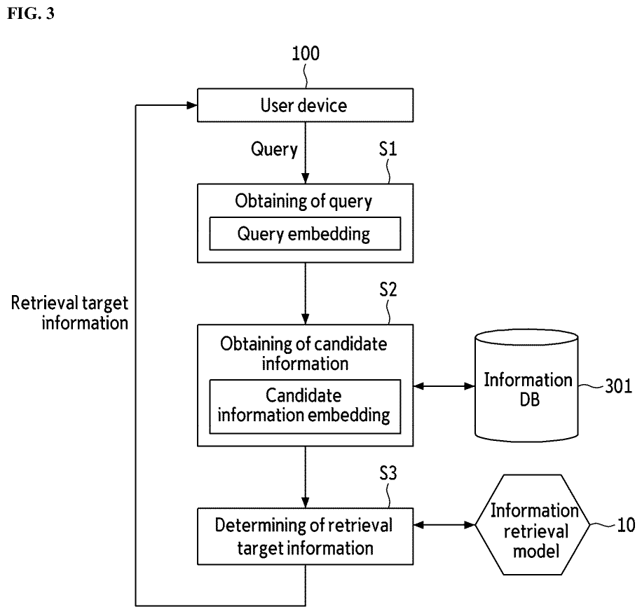

Next, detailed embodiments of a process in which the information retrieval system 200 automatically determines the plurality of pieces of retrieval target information corresponding to a query by performing the steps/operations as described with reference to FIG. 2 will be described with reference to FIG. 3.

FIG. 3 is a flowchart illustrating an example of all operations of the information retrieval system 200 according to some embodiments of the present disclosure.

Referring to FIG. 3, the information retrieval system 200 may obtain the query as the information retrieval target in S1, obtain the plurality of pieces of candidate information in S2, and determine retrieval target information corresponding to the query from among the plurality of pieces of candidate information in S3.

In S1, the query formed in the form of the embedding vector may be obtained.

For example, in S1, the information retrieval system 200 may receive the query in a natural language form from the user device 100, and may generate a query embedding vector of the received query using a query embedding vector model.

In S2 to S3, the information retrieval system 200 may retrieve retrieval target information corresponding to the query from the information DB 301 including a plurality of pieces of candidate information related to the query using the information retrieval model 10.

In S2, the candidate information formed in the form of the embedding vector may be obtained.

For example, in S2, the information retrieval system 200 may obtain an information embedding vector of the candidate information generated using an information embedding model from the information DB 301.

In another example, in S2, the information retrieval system 200 may obtain various types of candidate information including a natural language from the information DB 301, and may generate an information embedding vector of each of the obtained candidate information using the information embedding model.

In S3, the information retrieval system 200 may input the query to the information retrieval model 10, and automatically determine retrieval target information corresponding to the query, from among the plurality of pieces of candidate information included in the information DB 301, based on the similarity of each thereof to the query and/or the similarity between the plurality of pieces of information, using the output from the information retrieval model 10 in response to the input query.

The query input to the information retrieval model 10 in S3 may refer to a query (i.e., the query embedding vector) formed in the form of the embedding vector obtained in S1.

For reference, in the present disclosure, the information DB 301 may be referred to as an information pool (IP).

In S3, the information retrieval system 200 may determine a plurality of pieces of retrieval target information as many as a preset number from among the plurality of pieces of candidate information. In other words, the information retrieval system 200 may retrieve and extract a predetermined number of the retrieval target information corresponding to the query in the information DB 301 according to some embodiments of the present disclosure.

For example, when the preset number is k (k is 1 or greater), a process in which the information retrieval system 200 automatically determines k pieces of retrieval target information from among the plurality of pieces of candidate information based on the output from the information retrieval model 10 in S3 may be represented by an algorithm as shown in a following table.

The table as set forth below presents an algorithm in which the information retrieval system 200 determines the k pieces of retrieval target information corresponding to the query according to some embodiments of the present disclosure using pseudocodes.

In the table set forth below, the query embedding vector of the query q generated using the query embedding model M_{Q} is denoted by MQ_{(q)}, the information embedding vector of the candidate information info as generated using the information embedding model M_{I} is denoted by M_{I}(info), and Rᵢ denotes a retrieval target information set including the retrieval target information determined from among the plurality of pieces of candidate information info₁, . . . , infoₙ, wherein n is k or greater.

```
TABLE 1
Given a query q
for iteration i from 1 to K (the number of retrieved information):
  Rᵢ={info₁, ..., infoᵢ₋₁}: the set of retrieved information
  if i=0:
    - Rᵢ. append(argmax_{info}_{ₓ} {sim(MQ(q), M_{I}(infoₓ))})
else i=0:
  - Rᵢ. append(argmax_{info}_{ₓ} {sim(MQ(q), M_{I}(infoₓ))−λ *op(M_{I}(infoₓ), M_{I}(Rᵢ)|q)}), where λ
is a learnable scalar and op(M_{I}(infoₓ), M_{Q}(Rᵢ)|q) is pre-defined operation between a vector
M_{I}(infoₓ) and a set of vectors M_{I}(Rᵢ) conditioned on q.
```

Referring to a case where i is 0 in the above table, candidate information having the highest similarity sim (_{MQ}(q), M_{I}(info)) to the query among the plurality of pieces of candidate information may be determined as the retrieval target information, and may be included in the retrieval target information set Rᵢ.

The similarity to the query means similarity between vectors and may be cosine similarity. However, this is an example and the present disclosure is not limited thereto. For example, the similarity to the query may be a cosine similarity, a Euclidean distance, a jaccard similarity, a levenshtein distance, or the like.

In addition, referring to a case where i is not 0 in the above table, candidate information having the largest difference value between the similarity sim(M_{Q}(q), M_{I}(info)) thereof to the query and a value obtained by multiplying the similarity op(M_{I}(info), M_{I}(Rᵢ)|q) thereof to the retrieval target information set Rᵢ by the weight/may be determined as the retrieval target information from among the remaining ones of the plurality of pieces of candidate information other than the one or more pieces of candidate information included in the retrieval target information set Rᵢ.

For reference, in the present disclosure, a value as a criterion for determining a retrieval priority of the candidate information is referred to as a retrieval score (e.g., argmax_{info}_{ₓ} {sim(M_{Q}(q), M_{I}(infoₓ))} and/or argmax_{info}_{ₓ} {sim(M_{Q}(q), M_{I(}infoₓ₎₎−λ*op(M_{I}(infox), M_{I}(Rᵢ)|q)}).

According to the algorithm in the above table, the retrieval priority of the candidate information having the highest similarity sim (M_{Q}(q), M_{I}(info)) to the query among the plurality of pieces of candidate information may be the highest, and the retrieval priority of each of the remaining ones of the plurality of pieces of candidate information except for the candidate information having the highest similarity to the query may be determined according to an order in which a value of sim(M_{Q}(q), M_{I(}infoₓ₎₎−λ*op(M_{I}(infox), M_{I}(Rᵢ)|q).

In this regard, the weight A is a scalar value assigned to a similarity between a plurality of pieces of information serving as a criterion for determining retrieval target information corresponding to the query (i.e., a similarity between the candidate information and the retrieval target information set), and may be set as an optimized weight according to some embodiments of the present disclosure.

In the present disclosure, the weight/assigned to the similarity between the plurality of pieces of information may be referred to as a scalar, a learnable scalar, or the like.

The similarity between the plurality of pieces of information (that is, the similarity between the candidate information and the retrieval target information set) means the similarity between vectors and may be a cosine similarity. However, this is an example and the present disclosure is not limited thereto. For example, the similarity to the query may be a cosine similarity, a Euclidean distance, a jaccard similarity, a levenshtein distance, or the like.

op(M_{I}(info), M_{I}(Ri)|q) refers to a function predefined to calculate a similarity between the candidate information info and the retrieval target information set Rᵢ under a condition under which the query q is given, and M_{I}(Rᵢ) is an embedding vector set of one or more pieces of retrieval target information included in the retrieval target information set.

op(M_{I}(info), M_{I}(Rᵢ)|q) may be pre-defined as one of following functions op (v, {w₁, . . . , wₜ}|q) defined so as to calculate the similarity between a vector v and a vector set {w₁, . . . , wₜ} when the query q is given.

For example, op(M_{I}(info), M_{I}(Rᵢ)|q) may be defined as

$$op ( v , \{ {w}_{1} , … , {w}_{t} \} \vert q ) = {\sum }_{i = 1}^{t} sim ( v , {w}_{i} ) .$$

In another example, op(M_{I}(info), M_{I}(Rᵢ)|q) may be defined

$$op ( v , \{ {w}_{1} , … , {w}_{t} \} \vert q ) = \frac{1}{t} * {\sum }_{i = 1}^{t} sim ( v , {w}_{i} ) .$$

In still another example, when a standard deviation of the similarity between the candidate information included in the information pool IP and the query is [symbol] (M_{Q}(q), M_{I}(IP))=stddev_{info∈IP}{sim(M_{Q}(q), M_{I}(info))}, op(M_{I}(info), M_{I}(Rᵢ)|q) may be defined as

$$op ( v , \{ {w}_{1} , … , {w}_{t} \} \vert q ) = {\sum }_{i = 1}^{t} 𝒮 ( {M}_{Q} ( q ) , {M}_{I} ( IP ) ) * sim ( v , {w}_{i} ) .$$

In still yet another example, when [symbol] (M_{Q}(q), M_{I}(IP))=stddev_{info∈IP}{sim(M_{Q}(q), M_{I}(info))}, op(M_{I}(info), M_{I}(Rᵢ)|q) may be defined as

$$op ( v , \{ {w}_{1} , … , {w}_{t} \} \vert q ) = \frac{1}{t} * {\sum }_{i = 1}^{t} 𝒮 ( {M}_{Q} ( q ) , {M}_{I} ( IP ) ) * sim ( v , {w}_{i} ) .$$

The above examples are a list of examples of op(M_{I}(info), M_{I}(Rᵢ)|q), and is not limited to the listed examples. For example, op(M_{I}(info), M_{I}(Rᵢ)|q) may be defined as various types of functions to calculate a high value of the similarity between the candidate information info and the retrieval target information set Rᵢ.

According to some embodiments of the present disclosure, as described with reference to the above table, the information retrieval system 200 may determine retrieval target information corresponding to the query in consideration of a difference between the similarity thereof to the query and the similarity thereof with another retrieval target information.

When the candidate information has a high similarity to the query, but the similarity thereof to another candidate information determined as the retrieval target information prior to the candidate information is also high, a penalty is imposed on the retrieval score using the weight to readjust the retrieval priority of the candidate information, thereby preventing only a plurality of pieces of retrieval target information having high similarity to each other from being retrieved.

The information retrieval system 200 may transmit the retrieval target information (e.g., the retrieval target information set Rᵢ) determined according to steps/operations of S1 to S3 to the user device 100.

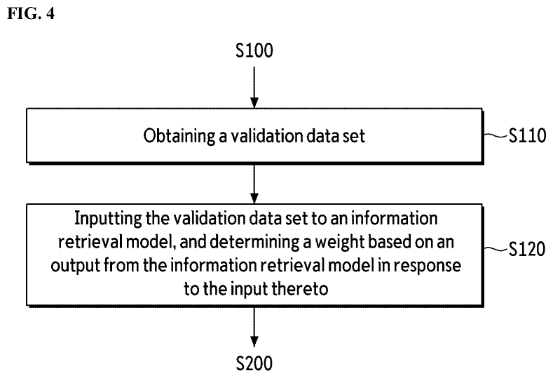

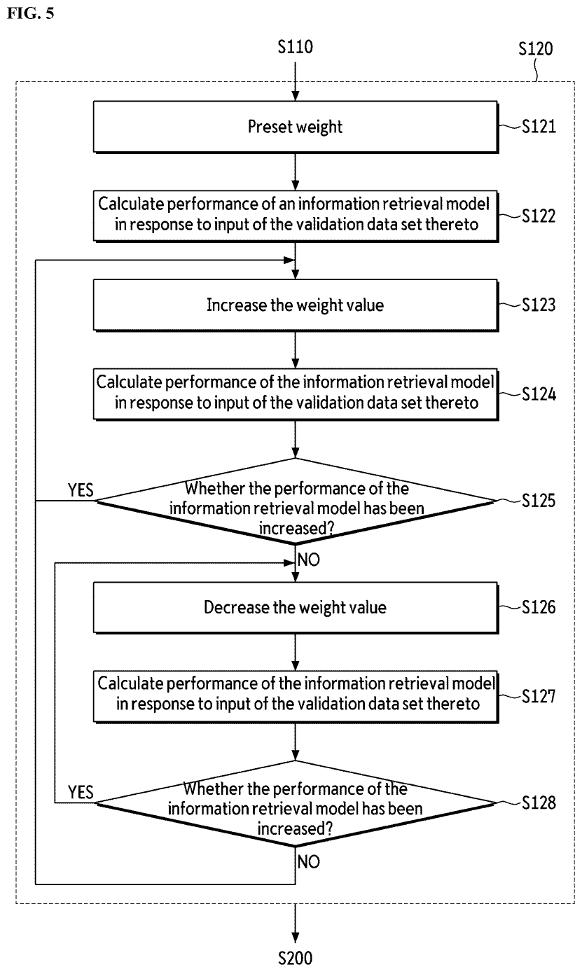

Next, embodiments related to a process of determining a weight of the similarity between the plurality of pieces of information will be described in detail with reference to FIGS. 4 to 5.

FIG. 4 is a flowchart illustrating a process of determining a weight of a similarity between retrieval target information and candidate information according to some embodiments of the present disclosure.

S100 and S200 of FIG. 4 may correspond to S100 and S200 of FIG. 2.

According to some embodiments of the present disclosure, as described with reference to FIG. 3, the retrieval target information corresponding to the query may be determined based on a difference between a similarity thereof to the query and a similarity thereof to another retrieval target information among the plurality of pieces of candidate information.

In this regard, when a weight of a value that is too low or is too high is applied to the similarity with another retrieval target information, information that does not correspond to the query may be determined as the retrieval target information.

According to some embodiments of the present disclosure, when a plurality of pieces of retrieval target information corresponding to the query are determined based on the output from the information retrieval model 10 in S200, an optimized weight may be applied so as to maximize the performance of the information retrieval model 10.

Referring to FIG. 4, a validation data set may be obtained in S110, and a weight may be determined using the output from the information retrieval model 10 in response to the input of the validation data set thereto in S120.

In S110, the obtained validation data set may include a query, candidate information related to the query, and a retrieval score corresponding to the candidate information.

In S120, the determined weight is that the initial weight set is optimized so that the performance of the information retrieval model 10 on the validation data set is maximized. In S200, retrieval target information corresponding to the query may be determined based on the similarity to which the optimized weight is assigned.

Hereinafter, referring to FIG. 5, a method for optimizing the weight based on the output from the information retrieval model 10 in S120 of FIG. 4 will be described in detail.

FIG. 5 is a flowchart illustrating an example of a process of optimizing a weight of a similarity between retrieval target information and candidate information according to some embodiments of the present disclosure.

S110, S120, and S200 of FIG. 5 may correspond to S110, S120, and S200 of FIG. 4.

Referring to FIG. 5, an initial value of the weight may be preset in S121, and the performance of the information retrieval model 10 in response to the input of the validation data set thereto may be calculated based on the weight set as the initial value in S122.

In addition, the weight may be set to a value increased from a current value of the weight in S123, and the performance of the information retrieval model 10 in response to the input of the validation data set thereto may be calculated based on the weight set to the increased value in S124.

In S123, increasing the value of the weight may mean increasing a magnitude of the value in a positive direction from the current value of the weight.

In addition, it may be determined whether the performance of the information retrieval model 10 in response to the input of the validation data set thereto is increased compared to that before the value of the weight is increased in S125.

When, in S125, the performance of the information retrieval model 10 in response to the input of the validation data set thereto is increased compared to that before the value of the weight is increased, S123 to S125 are repeatedly performed, so that an optimized value of the weight at which the performance of the information retrieval model 10 is maximized may be determined.

When, in S125, the performance of the information retrieval model 10 in response to the input of the validation data set thereto is reduced compared to that before the value of the weight is increased, the weight may be set to a value deceased from the current value of the weight in S126, and the performance of the information retrieval model 10 in response to the input of the validation data set thereto may be calculated based on the weight set to the decreased value in S127.

In S126, decreasing the value of the weight may mean that the magnitude of the value is decreased in a negative direction from the current value of the weight.

In addition, it may be determined whether the performance of the information retrieval model 10 in response to the input of the validation data set thereto is increased compared to that before the value of the weight is decreased in S128.

When, in S128, the performance of the information retrieval model 10 in response to the input of the validation data set thereto is increased compared to before the value of the weight is reduced, S126 to S128 are repeatedly performed, so that the optimized value of the weight that maximizes the performance of the information retrieval model 10 may be determined.

When, in S128, the performance of the information retrieval model 10 in response to the input of the validation data set thereto is reduced compared to that before the value of the weight is reduced, the optimized value of the weight that maximizes the performance of the information retrieval model 10 may be determined by repeatedly performing S123 to S125 again.

According to some embodiments as described with reference to FIG. 5, an algorithm for determining the optimized weight using the information retrieval system 200 may be represented with pseudocodes as shown in a following table.

TABLE 2

```
Given the validation data set, we set P(scalar) to be
the validation performance
corresponding to the scalar:
λ=0
best_{λ}=0
sgn=1
best_{perf}=0
for iteration i:
  if i = 0:
    - previous performance = P(λ)
  else:
    - Generate random number N
    - λ=max(λ+sgn*N, 0.0)
    - if P(λ)< previous performance:
      sgn *= (−1)
    - if λ == 0:
      sgn = 1
    - previous performance = P(λ)
  if P(λ)>best_{perf}:
    - best_{perf}= P(λ)
    - best_{λ}= λ
return best_{λ}
```

In the above table, the performance of the information retrieval model 10 in response to the input of the validation data set thereto as calculated based on the weight (or scalar) λ is P(λ), the optimized weight is best_{λ}, and the maximum value of the performance of the information retrieval model 10 is best_{perf}.

Referring to the above table, the weight is 0 or greater, and the information retrieval system 200 may set the initial value of the weight to 0, and then increase or decrease the magnitude of the value of the weight by an arbitrary value N in the positive direction (when sgn is set to 1) or the negative direction (when sgn is set to −1), and determine the value of the weight at which the performance of the information retrieval model 10 in response to the input of the validation data set thereto is maximized as the optimized value of the weight.

According to some embodiments of the present disclosure, as the weight assigned to the similarity between the plurality of pieces of information is optimized using the validation data set without updating/changing the parameter of the information retrieval model 10, the performance of the information retrieval model 10 may be increased with a small amount of computing resources and/or time resources.

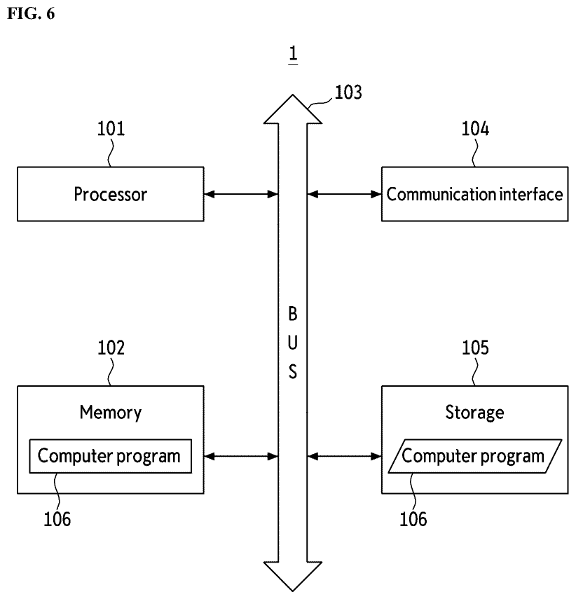

FIG. 6 is an illustrative hardware configuration diagram illustrating the computing device 160.

Referring to FIG. 6, the computing device 1 may include at least one processor 101, a system bus 103, a communication interface 104, a memory 102, which loads a computer program 106 executed by the processor 101, and a storage 105, which stores the computer program 106. Even though FIG. 6 depicts only components related to the embodiments of the present disclosure, it is obvious to one of ordinary skill in the art to which the present disclosure pertains that the computing device 1 may further include other generic components, in addition to the components depicted in FIG. 6. Moreover, in some embodiments, the computing device 1 may be configured with some of the components depicted in FIG. 6 omitted. The components of the computing device 1 will hereinafter be described.

The processor 101 may control the overall operation of each of the components of the computing device 1. The processor 101 may be configured to include at least one of a central processing unit (CPU), a micro-processor unit (MPU), a micro-controller unit (MCU), a graphics processing unit (GPU), Neural Processing Unit (NPU) or any form of processor well-known in the field of the present disclosure. Additionally, the processor 101 may perform computations for at least one application or program to execute operations/methods according to some embodiments of the present disclosure. The computing device 1 may be equipped with one or more processors.

The memory 102 may store various data, commands, and/or information. The memory 102 may load the computer program 166 from the storage 105 to execute the operations/methods according to some embodiments of the present disclosure. The memory 102 may be implemented as a volatile memory such as a random-access memory (RAM), but the present disclosure is not limited thereto.

The bus 103 may provide communication functionality between the components of the computing device 1. The bus 103 may be implemented in various forms such as an address bus, a data bus, and a control bus.

The communication interface 104 may support wired or wireless Internet communication of the computing device 1. Additionally, the communication interface 104 may also support various other communication methods. To this end, the communication interface 104 may be configured to include a communication module well-known in the technical field of the present disclosure.

The storage 105 may non-transitorily store at least one computer program 106. The storage 105 may be configured to include a non-volatile memory such as a read-only memory (ROM), an erasable programmable ROM (EPROM), an electrically erasable programmable ROM (EEPROM), a flash memory, as well as a computer-readable recording medium (e.g., non-transitory recording medium) in any form well-known in the technical field of the present disclosure, such as a hard disk or a removable disk.

The computer program 106, when loaded into the memory 102, may include one or more instructions that enable the processor 101 to perform the operations/methods according to some embodiments of the present disclosure. That is, by executing the loaded one or more instructions, the processor 101 may perform the operations/methods according to some embodiments of the present disclosure.

In the present disclosure, a computer-readable (non-volatile) storage medium can store at least one instruction or computer program, and at least one instruction or computer program, when executed by at least one processor, causes at least one processor to perform the methods and/or operations according to some embodiments of the present disclosure.

For example, the computer program 106 may include instructions for obtaining a query; inputting the query to a pre-trained information retrieval model; and determining a plurality of pieces of retrieval target information corresponding to the query among a plurality of pieces of candidate information, based on an output from the information retrieval model in response to the input thereto, wherein the plurality of pieces of retrieval target information may include first retrieval target information and second retrieval target information, wherein the first retrieval target information may be automatically determined, from among the plurality of pieces of candidate information, based on a similarity of each of the plurality of pieces of candidate information to the query, and using the output from the information retrieval model, wherein the second retrieval target information may be automatically determined, from among first remaining ones of the plurality of pieces of candidate information other than the first retrieval target information, based on a similarity of each of the first remaining ones to the first retrieval target information, and using the output from the information retrieval model.

According to some embodiments of the present disclosure, the performance of the information retrieval model may be increased by determining the retrieval target information based on the similarity between the plurality of pieces of candidate information.

According to some embodiments of the present disclosure, the optimized weight at which the performance of the information retrieval model is maximized may be determined, and the retrieval target information may be determined in consideration of the similarity between the plurality of pieces of candidate information to which the optimized weight is applied.

Various embodiments of the present disclosure and their effects have been described so far with reference to FIGS. 1 through 6. The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, it should be appreciated that the embodiments as described above are not restrictive but illustrative in all respects.

What is claimed is:

1. A method for retrieving information, the method being performed by a computing system, the method comprising:
obtaining a query; and
inputting the query to a pre-trained information retrieval model, and determining a plurality of pieces of retrieval target information corresponding to the query among a plurality of pieces of candidate information, based on an output from the information retrieval model,
wherein the plurality of pieces of retrieval target information includes first retrieval target information and second retrieval target information,
wherein the first retrieval target information is automatically determined using the output from the information retrieval model from among the plurality of pieces of candidate information, based on a similarity of each of the plurality of pieces of candidate information to the query,
wherein the second retrieval target information is automatically determined using the output from the information retrieval model from among first remaining ones of the plurality of pieces of candidate information other than the first retrieval target information, based on a similarity of each of the first remaining ones to the first retrieval target information.

2. The method of claim 1, wherein the second retrieval target information is determined from among the first remaining ones, based on a difference value between a similarity of each of the first remaining ones to the query and a value obtained by multiplying the similarity of each of the first remaining ones to the first retrieval target information a weight.

3. The method of claim 2, further comprising determining the weight,
wherein the determining of the weight includes:
obtaining a validation data set; and
inputting the validation data set to the information retrieval model, and determining the weight based on an output from the information retrieval model,
wherein the weight is obtained by optimizing a preset initial weight to maximize performance of the information retrieval model on the validation data set.

4. The method of claim 1, wherein the plurality of pieces of retrieval target information further includes third retrieval target information,
wherein the third retrieval target information is automatically determined using the output from the information retrieval model from among second remaining ones of the plurality of pieces of candidate information other than the first retrieval target information and the second retrieval target information, based on a similarity of each of the second remaining ones to the query, a similarity of each of the second remaining ones to the first retrieval target information, and a similarity of each of the second remaining ones to the second retrieval target information.

5. A computer program stored in a computer-readable recording medium, wherein when the computer program is executed by a computing device, the computer program causes the computing device to:
obtain a query; and
input the query to a pre-trained information retrieval model, and determine a plurality of pieces of retrieval target information corresponding to the query among a plurality of pieces of candidate information, based on an output from the information retrieval model,
wherein the plurality of pieces of retrieval target information includes first retrieval target information and second retrieval target information,
wherein the first retrieval target information is automatically determined using the output from the information retrieval model from among the plurality of pieces of candidate information, based on a similarity of each of the plurality of pieces of candidate information to the query,
wherein the second retrieval target information is automatically determined using the output from the information retrieval model from among first remaining ones of the plurality of pieces of candidate information other than the first retrieval target information, based on a similarity of each of the first remaining ones to the first retrieval target information.

6. A system for retrieving information, the system comprising:
at least one processor; and
at least one memory storing therein instructions,
wherein when the instructions are executed by the at least one processor, the instructions cause the at least one processor to:
obtain a query; and
input the query to a pre-trained information retrieval model, and determine a plurality of pieces of retrieval target information corresponding to the query among a plurality of pieces of candidate information, based on an output from the information retrieval model,
wherein the plurality of pieces of retrieval target information includes first retrieval target information and second retrieval target information,
wherein the first retrieval target information is automatically determined using the output from the information retrieval model from among the plurality of pieces of candidate information, based on a similarity of each of the plurality of pieces of candidate information to the query,
wherein the second retrieval target information is automatically determined using the output from the information retrieval model from among first remaining ones of the plurality of pieces of candidate information other than the first retrieval target information, based on a similarity of each of the first remaining ones to the first retrieval target information.

7. The system of claim 6, wherein the second retrieval target information is determined from among the first remaining ones, based on a difference value between a similarity of each of the first remaining ones to the query and a value obtained by multiplying the similarity of each of the first remaining ones to the first retrieval target information a weight.

8. The system of claim 7, wherein the instructions further cause the at least one processor to determine the weight,
wherein the determining of the weight includes:
obtaining a validation data set; and
inputting the validation data set to the information retrieval model, and determining the weight based on an output from the information retrieval model,
wherein the weight is obtained by optimizing a preset initial weight to maximize performance of the information retrieval model on the validation data set.

9. The system of claim 6, wherein the plurality of pieces of retrieval target information further includes third retrieval target information,
wherein the third retrieval target information is automatically determined using the output from the information retrieval model from among second remaining ones of the plurality of pieces of candidate information other than the first retrieval target information and the second retrieval target information, based on a similarity of each of the second remaining ones to the query, a similarity of each of the second remaining ones to the first retrieval target information, and a similarity of each of the second remaining ones to the second retrieval target information.
